(19) United States
(12) Patent Application Publication
(10) Pub. No.: US 2025/0272636 A1
(43) Pub. Date: Aug. 28, 2025

(54) SYSTEMS AND METHODS FOR CREATING AUTOMATION PROCESSES BASED ON PROCESS EVENT DATA

(71) Applicant: AUTOMATION ANYWHERE, INC., SAN JOSE, CA (US)

(72) Inventors: MATTHEW THOMAS WRIGHT, APTOS, CA (US); PETER RYAN MAGNUSON, BOSTON, MA (US)

(73) Assignee: AUTOMATION ANYWHERE, INC., SAN JOSE, CA (US)

(21) Appl. No.: 19/040,847

(22) Filed: Jan. 29, 2025

Related U.S. Application Data
(60) Provisional application No. 63/558,637, filed on Feb. 27, 2024.

(51) Int. Cl. G06Q 10/0631; G06F 9/54

(52) U.S. Cl. CPC G06Q 10/06316; G06F 9/542

(57) ABSTRACT

Systems and methods for producing programs and processes for performing tasks based on event data contained within event logs are disclosed. The systems and methods can involve processing event data such that relevant portions of the event data are provided to machine learning models to allow such systems to produce automation programs. The systems and methods can also involve providing instructions to a command package machine learning model, such as a large language model, that operates to propose command packages that contain automation actions, and providing instructions to an action machine learning model that selects automation actions, associated with the proposed command packages, to be incorporated within automation programs that can be used to automate the tasks.

### CROSS-REFERENCE TO RELATED APPLICATION

This application claims priority to U.S. Provisional Patent Application No. 63/558,637, filed Feb. 27, 2024, and entitled “SYSTEMS AND METHODS FOR CREATING AUTOMATION PROCESSES BASED ON PROCESS EVENT DATA,” which is hereby incorporated by reference herein.

### BACKGROUND OF THE INVENTION

Process automation systems enable automation of repetitive and manually intensive computer-based tasks. In an automation system, computer software, automation programs can be created to perform tasks that would otherwise be performed by humans. Some automation programs have the capability of mimicking the actions of a person in order to perform various computer-based tasks. For instance, an automation system can interact with one or more software applications through user interfaces, as a person would do. Such automation systems typically do not need to be integrated with existing software applications at a programming level, thereby eliminating the difficulties inherent to integration. Advantageously, automation systems permit automation of application-level repetitive tasks via automation programs that are coded to repeatedly and accurately perform the repetitive tasks.

Automation programs can be created by individuals of various levels of software development experience. Low code software development systems tend to allow those with lesser levels of software development experience create automation programs. However, creating automation programs may still require significant amounts of time and effort, and at times, at least a moderate level of development experience. At the same time, process mining systems review, record, and assess processes and the actions being performed using software applications for the purpose of completing tasks. Such process mining systems are capable of producing event logs containing data related to the various actions.

Accordingly, there remains a need to facilitate development of automation programs with greater efficiency and reduced user burden.

### SUMMARY

Systems and methods for producing programs, such as automation programs, and processes for performing tasks based on event data contained within event logs are described herein. Event logs can, for example, be produced by process mining systems. The systems and methods can involve processing event data such that relevant portions of event data are provided to machine learning models to allow such systems to produce automation programs. The systems and methods can also involve providing instructions to a command package machine learning model, such as a large language model, that operates to propose command packages that contain automation actions, and providing instructions to an action machine learning model that selects automation actions, associated with the proposed command packages, to be incorporated within automation programs that can be used to automate the tasks.

The invention can be implemented in numerous ways, including as a method, system, device, or apparatus (including computer readable medium). Several embodiments of the invention are discussed below.

As a computer-implemented method for producing an automation program, one embodiment can, for example, include at least: receiving, by a data processing module, an event log comprising event data related to one or more user actions performed using one or more software applications for the purpose of completing a task; separating the event log into a plurality of event groups wherein each of the event group includes at least one or more events, and wherein each of the event groups has associated therewith the event data for the one or more events of the corresponding event group, wherein each event includes data regarding a user action; providing command package inputs, by a model integration module, to a command package model, the command package inputs including a role definition instruction, command package domain knowledge, the event data for the one or more events of the corresponding event group, command package model functional instructions, and command package model output instructions; identifying a command package name, by the command package model, based on the command package inputs, wherein the command package name is associated with a command package that contains one or more actions that can be executed within one or more of the software applications; providing action model inputs, by the model integration module, to an action model, wherein the action model inputs include at least a role definition instruction, action domain knowledge, the event data for the one or more events of the corresponding event group, action model functional instructions, the command package name identified by the command package model, and action model output instructions; identifying one or more action names, by the action model, based on the action model inputs, wherein the identified one or more action names are associated with respective one or more actions that are suitable for automating the user actions in the event log; and combining, by a sequencing module, the respective one or more actions suggested by the action model in a sequence wherein execution of the respective one or more actions automates the events within the corresponding event group.

As a computer-implemented method for producing an automation program, another embodiment can, for example, include at least: receiving, by a data processing module, an event log comprising event data related to one or more user actions performed using one or more software applications for the purpose of completing a task; separating the event log into a plurality of event groups wherein each of the event group includes at least one or more events, and wherein each of the event groups has associated therewith the event data for the one or more events of the corresponding event group, wherein each event includes data regarding a user action; providing command package inputs, by a model integration module, to a command package model, the command package inputs including at least the event data for a selected one of the event groups; identifying a command package name, by the command package model, based on the command package inputs, wherein the command package name is associated with a command package that contains one or more actions that can be executed within one or more of the software applications; providing action model inputs, by the model integration module, to an action model, wherein the action model inputs including at least event data the selected one of the event groups and the command package name identified by the command package model; identifying one or more action names, by the action model, based on the action model inputs, wherein the one or more action names are associated with respective one or more actions that are suitable for automating the user actions in the event log; and combining, by a sequencing module, the respective one or more actions identified by the action model in a sequence wherein execution of the one or more actions automates the events within an event group.

As a computer readable medium including at least computer program code tangibly stored therein for producing an automation program, one embodiment can, for example, include at least: computer program code for receiving an event log comprising event data related to one or more user actions performed using one or more software applications for the purpose of completing a task; computer program code for separating the event log into a plurality of event groups, each of the event group includes at least one or more events the event data for the one or more events; computer program code for providing command package inputs, by a model integration module, to a command package model, the command package inputs including a role definition instruction, command package domain knowledge, the event data for the one or more events of the corresponding event group, command package model functional instructions, and command package model output instructions; computer program code for identifying a command package name for the corresponding event group, the command package name being associated with a command package that includes or supports one or more actions that can be executed within one or more of the software applications; computer program code for identifying one or more actions based on action model inputs, wherein the identified one or more actions are suitable for automating the user actions in the event log; and computer program code for combining the identified one or more actions in a sequence, wherein execution of the sequence operates to induce the identified one or more actions that serve to automate the events within the corresponding event group.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like elements, and in which:

FIG. 1 is a block diagram of an automation environment according to one embodiment.

FIG. 2 is a diagram of a process flow for processing event logs for use with machine learning models to produce automaton programs according to one embodiment.

FIG. 3 illustrates a portion of a process definition document according to one embodiment.

FIGS. 4A and 4B each illustrate an event group of the process definition document in spreadsheet format according to certain implementations.

FIG. 5. illustrates a process flow for producing automaton programs according to one embodiment.

FIG. 6 illustrates a list of command packages, actions and corresponding descriptions according to one implementation.

FIG. 7 illustrates a process flow for providing instructions to large language models according to one embodiment.

FIG. 8 is a block diagram of a robotic process automation system according to one embodiment.

FIG. 9 is a block diagram of a generalized runtime environment for bots in accordance with another embodiment of the robotic process automation system illustrated in FIG. 8.

FIG. 10 is yet another embodiment of the robotic process automation system of FIG. 8 configured to provide platform independent sets of task processing instructions for bots.

FIG. 11 is a block diagram illustrating details of one embodiment of the bot compiler illustrated in FIG. 10.

FIG. 12 is a block diagram of an exemplary computing environment for an implementation of a robotic process automation system.

### DETAILED DESCRIPTION OF CERTAIN EMBODIMENTS

Systems and methods for producing programs and processes for programmatically performing business and personal tasks using software application programs are disclosed. The systems and methods involve receiving process event logs from a process mining module where the event data within the event logs relates to details of how a human user performed tasks using one or more software applications. This process event data can then be processed to identify, arrange, and format certain portions of the event data so that it can be provided to machine learning models. The processed event data can be provided, along with other certain inputs and instructions, to a command package machine learning model that can identify command packages that contain one or more actions that can be employed by a software automation platform. Then the identified command packages, along with certain other instructions, can be provided to an action machine learning model that can identify actions within the command packages that can be employed by the software automation platform to programmatically perform actions to perform the tasks that were otherwise manually performed by human users. In some implementations, the machine learning models are large language models and inputs provided to such models include domain knowledge related to a software automation platform as well as command packages and actions available for use by such a platform. Other inputs also include large language model role definition inputs, functional instructions, and output instructions.

The systems and methods disclosed herein advantageously allow an automation production system to automatically produce an automation program based off event log data. This capability shortens the time and effort needed to benefit from process automation features of automation platforms, which otherwise cannot be realized until after sometimes lengthy efforts to design and build such automations where such efforts require software programming, or at least low coding, skills and experience.

In some implementations, the systems and methods disclosed herein can be used with process automation platforms that include robotic process automation (RPA) capabilities. RPA systems use computer software to emulate and integrate the actions of a user or person interacting within digital systems. In an enterprise environment, the automation systems are often designed to execute business processes, and most notably to handle high-volume, repeatable tasks that previously required humans to perform. In some cases, the automation systems can use artificial intelligence (AI) and/or other machine learning technologies in various aspects of automation in addition to features for producing automation programs. The automation systems can also provide for creation, configuration, management, execution, and/or monitoring of software automation processes.

A software automation program is sometimes referred to as a software robot, software agent, or a bot. Software automation programs can accurately and repeatably perform a task or workflow they are tasked with. As one example, a software automation program can locate and read data in a document, email, file, or window. As another example, a software automation process can connect with one or more Enterprise Resource Planning (ERP), Customer Relations Management (CRM), core banking, and other business systems to distribute data where it needs to be in whatever format is necessary. As another example, a software automation program can perform data tasks, such as reformatting, extracting, balancing, error checking, moving, copying, or any other desired tasks. As another example, a software automation program can grab data desired from a webpage, application, screen, file, or other data source. As still another example, a software automation program can be triggered based on time or an event, and can serve to take files or data sets and move them to another location, whether it is to a customer, vendor, application, department or storage. These various capabilities can also be used in any combination.

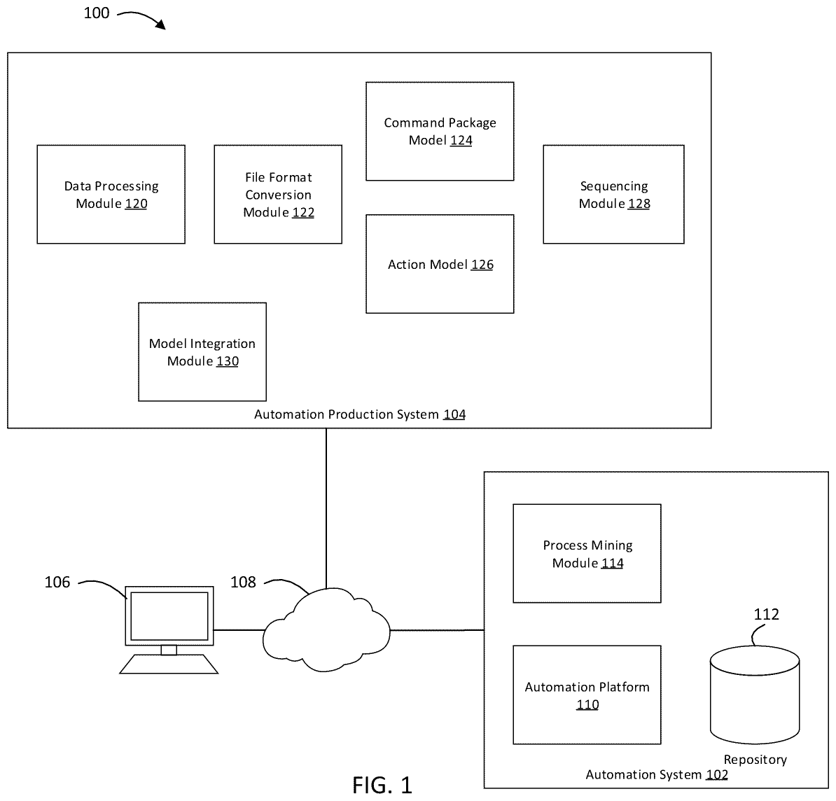

Embodiments of various aspects of the invention are discussed below with reference to FIGS. 1-12. However, those skilled in the art will readily appreciate that the detailed description given herein with respect to these figures is for explanatory purposes as the invention extends beyond these limited embodiments.

FIG. 1 is a block diagram of an automation environment 100 according to one implementation. The automation environment 100 is a computing environment that supports the automation of processes, such as business or personal processes. The automation environment 100 includes systems, devices, and services that include an automation system 102, a client device 106 that allows a user to interact with the automation system 102, and an automation production system 104, each of which are interconnected through a network 108 such as the internet, local area networks, wide area networks, and/or private or public clouds. It should also be understood that multiple client devices 106 could likewise be connected to the other components within the automation environment 100. The client device 106 (or multiple client devices) can, for example, be an electronic device having computing capabilities, such as a mobile phone (e.g., smart phone), tablet computer, desktop computer, portable computer, server computer, and the like.

The automation system 102 can include an automation platform 110, a repository 112, and a process mining module 114. The automation platform 110 can provide process automation functionality for automating processes by providing components for creating, editing, executing, and managing automation programs. In some instances, these automation programs may also be referred to as “software robots” or “bots”. For example, these automation programs, can interact with one or more software applications that a user uses to perform a business task. A task refers a work assignment, a project, or a job that typically has a goal or objective, and which can be achieved by performing one or more actions by using one or more software applications. These software applications can vary widely with a user's computer system and specific tasks to be performed thereon. For example, software application being used might be word processing programs, spreadsheet programs, email programs, ERP programs, CRM programs, web browser programs, any many more. These automation programs may interact with the one or more software applications through the graphical user interfaces or Application Programming Interfaces (APIs) of the respective software applications. The repository 112 can store automation programs, including those created by the automation system 102 or elsewhere, and various files that may be needed by or related to various features provided by the automation system 102. The processing mining module 114 can provide functionality to observe, record, and assess how processes and tasks are performed and completed with the goal of gaining insights to as to how such processes and tasks can be performed more efficiently and quickly. For instance, the process mining module 114 may provide processing mining logs that show the multiple steps involved with performing business tasks such as on-boarding new company employees or for paying accounts payable invoices. Such mining logs may reflect the software applications human users utilize to complete tasks, user interface windows used within each of the software applications, user interface control elements that users interact with, text that was entered into text fields, buttons clicked on a mouse at each step, and other various and details regarding how a task is accomplished. The automation system 102 is accessed and utilized by a user using the client device 106 that is connected through network 108.

The automation production system 104 includes a data processing module 120, a file format conversion module 122, a command package model 124, an action model 126, a sequencing module 128, and/or a model integration module 130 (or a machine learning (ML) integration module). The data processing module 120 is a software, firmware, or hardware device for reviewing, identifying, extracting, and manipulating data received in one form and transforming it into another form. For the purposes of the methods described herein, the data processing module 120 can receive input data from the process mining module 114 and manipulate and transform such data into a form and structure suitable for providing as input into machine learning models. The file format conversion module 122 receives the output of data processing module 120 and converts the format from one format to another such that it is in a format that is expected by the command package model 124 and the action model 126. For instance, file format conversion module 122 can receive input in one format and convert it into a comma separate value, or CSV, format, which is at least one data format that is suitable for providing data to large language models.

The command package model 124 is a machine learning model, such as a large language model, that can be used to identify command packages suitable for use to automate processes. Command packages are collections of commands or actions, files, libraries, and dependencies then, when used together, can perform one or more actions needed to automatically perform tasks that are part of a process. By identifying suitable command packages, the automation production system 104 can then be able to identify the suitable actions within each of the command packages that are needed to automate processes. The action model 126 is a machine learning model, such as a large language model, that can be used to identify suitable actions within each of the command packages, which were identified by the command package model 124, where the identified actions can be used to automate steps needed to automate processes. The sequencing module 128 can receive the one or more selected actions from action model 126 and then put the actions in a sequence such that the ordered actions perform the process steps in an order that results in the completion of processes.

The model integration module 130 can facilitate the utilization and integration of the command package model 124 and the action model 126. The model integration module 130 provides a design and execution framework for developing applications that incorporate cognitive or artificial intelligence technologies. Such systems facilitate sharing inputs and outputs between multiple machine learning, large language models, or the like so they can be utilized in combination to achieve system design goals. In some instances, model integration module 130 can utilize LangChain, which is an open-source suite of products that helps you build, run, and manage applications with large language models (LLMs), available at www.langchain.com. The model integration module 130 can also gathers and provides various types of information, prompts, tuning prompts to each of the models.

The automation environment 100 and the concepts disclosed herein can also be used to produce process flows, in addition to automation programs. The process flows refer to sequences of actions and steps taken by automation programs and by humans for the purpose of completing a task or a series of business or personal tasks. As one example, a user may as request the automation environment 100 to produce or suggest a process flow for a corporate process for onboarding a new employee that involves receiving the name, employee number, and other employee identifying information, having an automation program perform the step of sending this information into a human resources (HR) management system, having a human HR manager approve the employee for a certain configuration of computer systems for a work station, and then having the automation program perform the step of sending an action item in the form of an ticket item to instruct the information technology (IT) team to provision the new employee with the selected computer system configuration. As can be seen, this process flow involves steps taken by both the automation program and a human being.

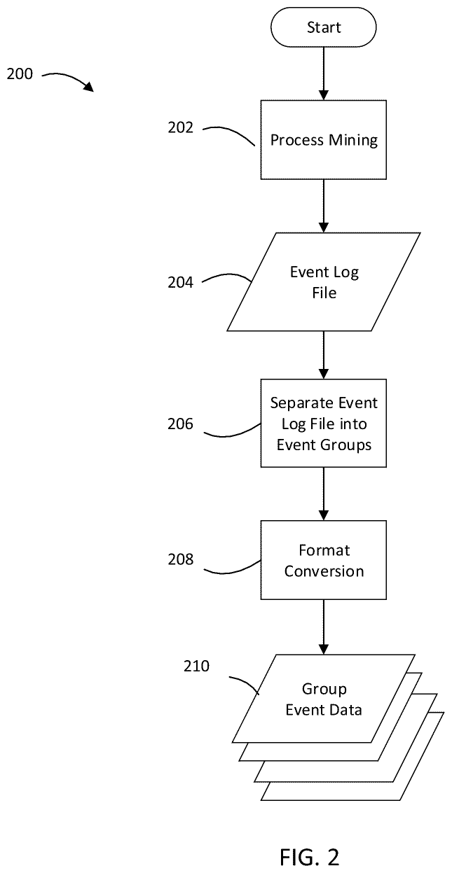

FIG. 2 illustrates a process flow 200 for processing an event log file for use by a machine learning model according to one embodiment. At block 202, a process mining module, such as process mining module 114 of FIG. 1, can review, record, and assess processes and the various steps performed during the process by a user to complete tasks. The process mining module 114 can produce a file or document called a process event log file or an event log file 204 that contains details about steps and actions taken, e.g., by a human user, to complete all or a portion of a task.

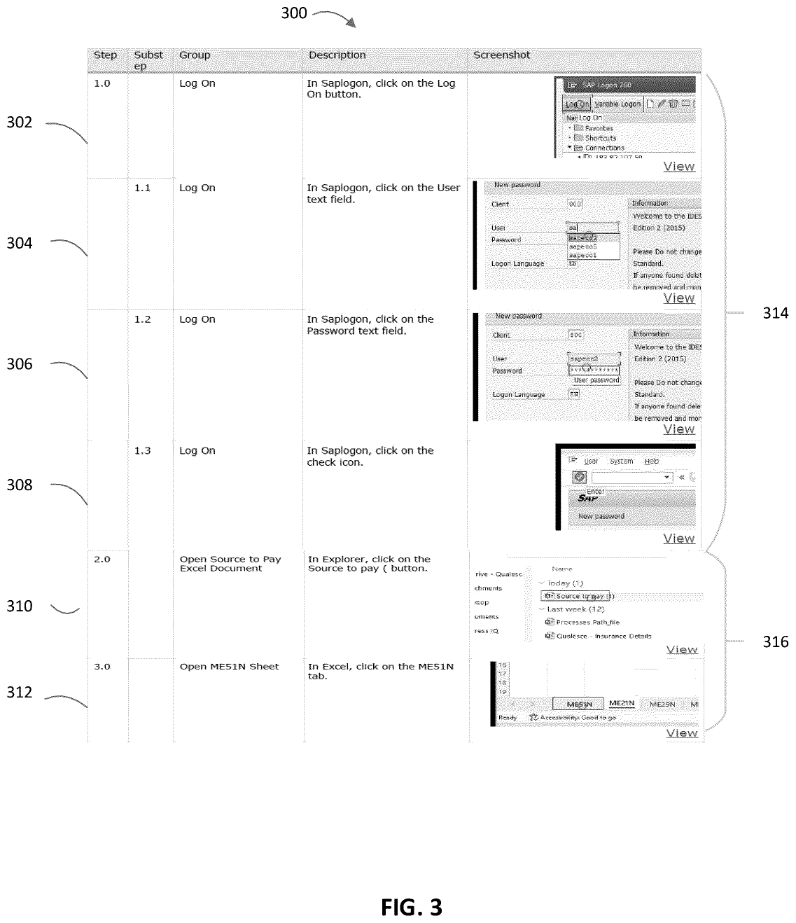

FIG. 3 illustrates a representation of an event log 300 according to one embodiment. The event log 300, which may be a portion of a process definition document, shows details of each action taken by a user in order to complete some or all of the steps needed to complete a job task or business process. The event log 300 can be a simplified process definition document. A full process definition document may include a large number of individual actions needed to complete a job task. The event log 300 includes rows 302, 304, 306, 308, 310, and 312 that each describe respective actions taken by a user. Each of these actions can also be called events, steps, process events, or process steps. It should be understood that the actions within the event log 300 could have been performed by a user or by another automation system.

The event log 300 illustrated in FIG. 3 also denotes an event grout 314 and an event group 316. The event group 314 represents a group of individual events or actions in rows 302-308 that were performed on a single software application program, such as an enterprise resource planning (ERP) software application. In the example of FIG. 3, the ERP software application is that which is provided by SAP SE, but it should be understood that this ERP software application name is for exemplary purposes only and could be one of many types and brands of software applications. The event group 316 includes rows 310 and 312 for an action taken on a different software application, such as the Explorer Internet browser application provided by Microsoft Corp.

The event log 300 as presented in FIG. 3 is in a format that is suitable for comprehension and review by humans. The event log 300 includes: Step and Sub-Step columns that enumerate the actions in hierarchical numerical order, Group column that includes a title describing what each grouping of actions relates to in terms of the purpose of each grouping of actions, a Description column that provides a human readable description of the action taken in each step or row, and a Screenshot column that provides a screenshot of the user interface of the software application to show how the action taken appeared to its user. For example, in row 302 a user performs the first step of the event group 314, step 1.0, having Group title of “Log On”, which reflects that a user performs steps in an effort to log onto a particular software application. Description for this row, as provided in its Description column, explains that the user is attempting to log onto an enterprise resource planning (ERP) software application by clicking a “Log On” button in the ERP applications user interface. This action as it appears in a user interface screen is shown in the associated Screenshot column screenshot and the “Log On” button in the Screenshot column screenshot is visually designated by being highlighted to indicate its selection. Then, in row 304, the second action in the event group 314 is taken to achieve the user's goal of logging on where the user mouse clicks in a user (or user name) text field.

In FIG. 3, the event groups 314 and 316 each include events where a user interacted with a single software application. By dividing the event logs into smaller grouping of events, or event groups, each event group can be individually input into the command package model 124 or the action model 126 to allow these models to provide outputs with more desirable results. For example, by providing an event group where each of the events relate to actions that are performed within a single software application, the models, in some instances, are able to identify command packages or actions for inclusion in an automation program that more effectively automates a process. However, in alternative implementations the groupings could be assigned based on a different commonality or factors. For example, in other implementations the groupings may include actions that were taken within a single user interface screen of a particular software application.

The steps shown in FIG. 3 relate to a portion of an event log that describes steps taken to open a spreadsheet file and an ERP software application, to take information in the spreadsheet and to enter such information into the ERP application.

In block 206, the event log file 204 is separated into individual groups of events, or event groups. In some implementations, the separate groups of events include one or more successive events for processing a task. These event groups can be separated based on various factors. In one implementation, successive events where actions are performed within a single software application are identified and set within groups. In some instances, there may be many successive events within a group, but in other instances there may only be one action performed with a certain software application before a next action is executed within a different software application. By separating events into groups based on actions performed within certain software applications, each of the groups of events can be input into a machine learning model to achieve more desirable model outputs. In other implementations, the grouping of events may be formed based on successive events that occur within specific user interface or internet browser windows. In some instances, such groups are at a lower level and each of the groups may have a smaller number of events.

Rows 302, 304, 306, and 308 of FIG. 3 represent the event group 314 since each of the events represent actions performed within a single ERP software application. Row 310 represents a group that includes a single event 310 that represents an action performed within a different software application, i.e., an event within an Internet browser. Separating the event log into smaller groups of events may also be referred to as chunking the event logs into individual chunks.

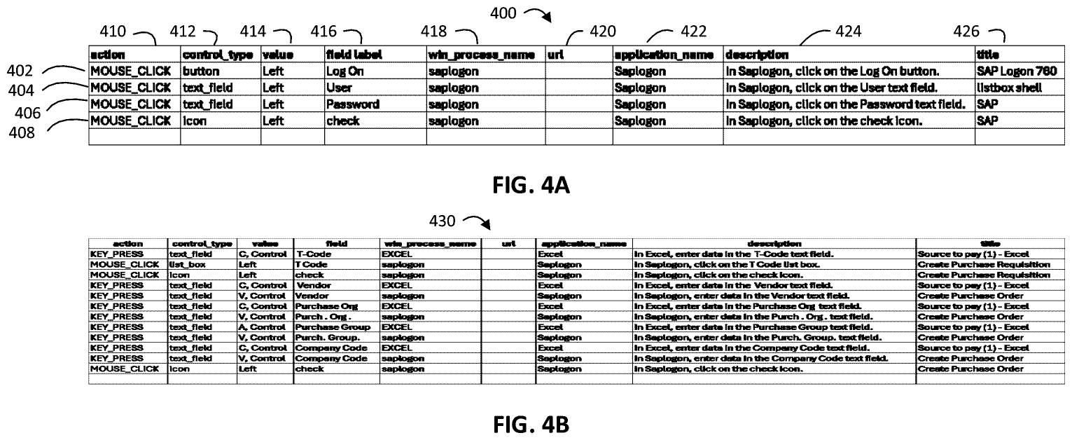

In block 208, each of the groups of events are converted to a data format that is more suitable for inputting into a machine learning model. In some instances, as shown in FIGS. 4A and 4B, the event log 300 may be converted to a spreadsheet format that may contain additional information about each of the user actions. When FIG. 4A illustrates a grouping of events that are organized in a spreadsheet format 400, where events of a given event group are associated with an EPR software application. The spreadsheet version of the event group 400 has rows 402, 404, 406, and 408 where each row represents an event and each of the columns 410-426 includes details regarding the corresponding event. Column 410, an action column, represents an action that a user performed to cause execution of certain functionality. Rows 402-408 show that a user performed a mouse click or pressed a button of a mouse peripheral user device to trigger the event. Other examples of actions may include pressing a keyboard button. Column 412, a user interface control type column, represents a type of user interface element that was interacted with as a result of an action taken by a user. For example, in row 402, a user clicked a mouse button to select a user interface button within a software application user interface, as indicated in the user interface control type column 412. Other examples of user interface control types include text fields, list boxes, radio buttons, check boxes, drop down list selectors, slider bars, tables, table columns, tabs, icons, and the like.

Column 414, a value column, represents specifics, such as a value, regarding the action taken in column 410. For example, for a mouse click action, the value could be a left or right mouse click action. For an action of pressing a keyboard button, the value could be the specific key that was pressed. The column 416, a field label column, or what may be referred to as a control type label, represents a label of the user interface control type. For example, the field label for a button user interface control type could be “ok”, “enter”, “delete”, or any other label of keys commonly found on computing device keyboards. Column 418, OS process name column or Windows process name column 418, represents a computer's operating system's API name for the software application within which an action takes place. In some implementations, a user uses a computer that runs on a Microsoft Windows® operating system and so the API name is the name used within the Windows operating system. In the event 402, the mouse click action takes place on the login screen of an ERP application developed by SAP

Column 420, URL column, represents the website URL of the software application with which a user interacts with when the software application is provided via an Internet browser. Column 422, application name column, represents the name of the software application within which a user's event or action occurs. Column 424, description column, represents a human readable description of an event, where the description may indicate the action taken, the software application within which the action was taken. Column 426, title column, represents the title of the active window of the software application within which a user's action took place. The window title may be the title obtained from the operating system API accessed information.

FIG. 4B illustrates event information 430 for a series of events in a spreadsheet format, according to one embodiment. As in FIG. 4A, each of the rows of event information 430 represents a single action or event. The events illustrated in FIG. 4B, however, occur in two separate software applications where a user repeatedly interacts with one software application and then the other.

In some instances, the groups of events in spreadsheet format in FIGS. 4A and 4B can be converted into a text format, such as a text string or a comma separated value (CSV). Converting the event data into different formats can allow for such data to be input into machine learning models in a format that is more easily understood and utilized by such models. In some cases, machine learning models produce more desirable results when input data is in a text format, such as a text string or CSVs. However, it should be understood that conversion of event data can be performed, or not, if it is determined that such format conversions allow for more accurate model suggestion. In some implementations, it may be decided that file format conversions are not necessary, or it could be decided that converting such information into spreadsheet format is sufficient to allow a machine learning model to provided sufficiently accurate suggestion.

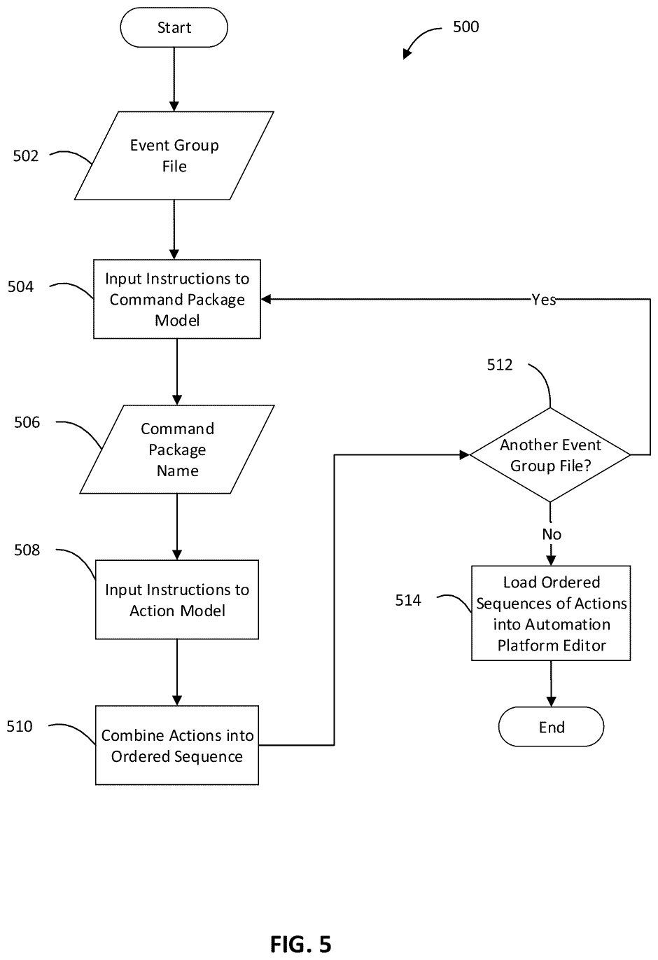

FIG. 5 illustrates a process flow 500 for producing at least one automation program using machine learning models according to one embodiment. The process flow 500 begins after event data is processed by data processing module 120 as described earlier, such that the processed event data can be provided to the machine learning models. An event group file 502 can be made available. The event group file 502 can be provided to command package model 124.

In block 504, additional data is provided to the command package model 124 as inputs so that it can use the additional data to identify and output one or more command package names 506 that are suitable for automating the processes defined in event logs. At block 508, the identified command package names 506 are provided as input data into the action model 126. Command packages are files that contain one or more actions that can be included in automation programs such that the actions can perform one or more functions for automating processes. In some implementations, the command package model 124 is a large language model, and providing input data to the large language model (LLM) can be referred to as prompting the LLM. The model integration module 130 coordinates the provision of inputs to each of the command package model 124 and the action model 126.

A set of data and instructions is provided to command package model 124 each time an event group, or a grouping of event data, is provided so that the command package model 124 can identify one or more command packages for automating the events in the event group. In this way, the command package model 124 provides outputs for one group at a time and is able to provide one or more command package names that contain actions that will more accurately form part of automation programs to automate processes as defined in the event logs. The types of instructions provided to the command package model 124 can include: 1) role definition instructions; 2) functional instruction; 3) domain knowledge; 4) event data for a grouping of events; 5) output instructions. In some implementations, output constraints can also be provided to the models. In alternative implementations, a portion of the listed input types are provided to the command package model 124, and in other implementations, additional types of instructions may be provided.

Role definition instructions or prompts give each of the models a point of view or role within which to set itself so the models can develop outputs or solutions as if they were actors having such points of view or roles. Role definition instructions provide guidance to LLM's such they can tailor their approaches to producing outputs, the tone of the outputs they provide, and the content of their outputs. Since LLM's are trained on very large amounts of data, much of which is publicly accessible over the Internet, instructions can be somewhat general in nature. One example of a role definition instructions for the purposes of creating automation programs is:
You are a smart assistant for a software process automation platform and you are to assist a developer develop an automation program.

The role definition instruction may also name specific process automation platforms, e.g., automation platform provided by Automation Anywhere, Inc. The above role definition instruction may be worded differently in alternative embodiments so long as the model is able to process and identify the meaning of the instruction.

Functional instructions are inputs to the models that instruct the models as to the desired functions or actions should be taken by the model, e.g., save or copy files, send emails, or extract information from webpages, etc. Functional instructions also instruct as to the type of outputs that are desired to be produced by the models and may also include guidance as to how such outputs should be produced and how certain inputs should be considered and used. Examples of functional instructions for providing automations can include:
You are given a series of task mining logs restricted to a single application.
You will select an automation package most relevant to that single application.
You will pay most attention to the field “application_name”.

Domain knowledge instructions include information that the models can draw from in order to perform the functions and produce the outputs required by the user's automation program request. Domain knowledge input can indicate specific event parameters, which are the types or categories of data provided to the command package model 124 for each event that is provided as part of an event group. By indicating specific event parameters, command package model 124 can put emphasis on these specific parameters out of multiple parameters for the purpose of identifying a command package name. FIGS. 4A and 4B each show examples of event logs 400 and 430 where the event logs are in spreadsheet format. An example of domain knowledge input to emphasize certain event parameters to the command package model 124 can include:

The event logs have the following parameters:
“application_name”: represents the operating system software application name from which the event capture was taken.
“window title”: the title of the active window pulled from the operating system API information.
“URL”: If the user is using a web-based application, this is the website's URL.
“OS_process_name” or “application API name”: the operating system API name of the software application.

The wording and structure of the above parameters, and of other described parameters, can vary from what is shown so long as the command package model 124 and the action model 126 are sufficiently able to discern the meaning of the parameters.

The event group files 502 received by command package model 124 can include data relating to each event in an event group. In block 504, data for an event can be provided in an instruction format such as shown below:
OS_process_name, application_name, URL, title (the event parameter types)
EXCEL, Excel,, Source to pay (1)—Excel (the event data for each of the parameter types)

The event data in the above example shows that this particular event corresponds to an event using an API for the Microsoft Excel spreadsheet application, that the name of the application is Excel, that there is no URL because the application the user is not a web-based application, and that the title of the active window within which a user was performing an action was “Source to pay (1)—Excel”, which means the user was in an Excel window for a spreadsheet called “Source to pay (1)”. In alternative implementations, the event log parameters may be presented in a different order. This event log data gets programmatically entered, but the model integration module 130, as input into the command package model 124.

As shown in FIGS. 4A and 4B, event logs may have many parameters, as represented by each column of the spreadsheets, but by pointing out these specific event log parameters, the command package model 124 can put emphasis on these parameters to better understand each event for the purpose of identifying one or more command packages for automating tasks. In alternative implementations, domain knowledge instructions can point out additional of the event parameters or a different combination of the parameters.

Additional domain knowledge inputs can include providing information about the command packages that available for use by the automation system 102 so that the automation production system 104 will suggest command packages that can be utilized by automation platform 110 to automate processes. According to one implementation, an instruction or input to inform an LLM as to the available command packages and actions, can be as follows:
The user would like to create an automation workflow by understanding which command packages they would need. Here are available command packages and a description of what they do: {package_context}.

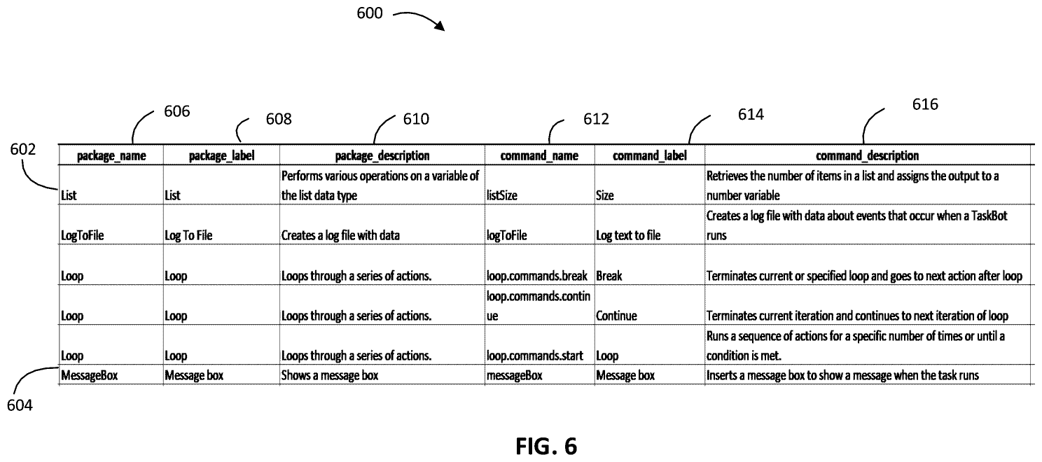

{package_context} represents a field within which available command package information will be inserted so that it can be provided to the LLM. In some instances, the available command package information is a spreadsheet formatted list 600 as seen in FIG. 6. Spreadsheet list 600 includes rows, such rows 402 and 404, and columns of respective command packages and actions (also referred to as commands). Column 606 has a column header title of package_name as this column includes the package name of each listed package. Package_name can be a name or identifier for use by automation system 102 and by command package model 124. Column 608 has a column header of package_label, which is an identifier for packages that can be more easily readable by humans, and which could be more easily recognized by large language models. Column 610 has a column header title of package_description as this column includes a description of the one or more commands that correspond to or are contained within a respective command package. Column 612 has a column header title of command_name as this column includes the name of each command in a respective row. Column 614 has a column header title of command_label which is an identifier for commands that can be more easily readable by humans, and which could be more easily recognized by large language models. Column 616 has a column header title of command_description as this column includes a description of each command listed in the spreadsheet 600.

In some implementations, {package_context} can be provided to LLMs in a text string format, such as in CSV format, by converting the command package and action information in spreadsheet format into text string format.

The event data for event group may be provided to the LLM using an instruction that reads as follows:
Event logs: {event_logs}

{event_logs} represents a field into which event data for an event group will be inserted, e.g., by the model integration module 130. In some implementations, events for one group of events is provided in each time a model is requested to provide output, however in other implementations events for multiple groups of events may be provided. Each group of event logs can be provided in a spreadsheet format as seen in FIGS. 4A and 4B. In other implementations, the event log data in spreadsheet format can be converted to text string format, such as CSV format, before being provided to an LLM.

Output instructions to be provided to LLMs serve to request the models to produce desired outputs that can be used to form a requested automation program or a portion thereof. Output instructions can request outputs of certain types and in certain formats, and according to programming syntax and structure. One example of an output instruction is as follows:
Out of the list of packages, identify which packages could be used for the automation workflow. Put the package name in the “names” attributes of this JSON: {response_json}.

This output instruction requests the command package model 124 to output a command package name that is suitable for automating the group of events that are also being input into the model. This particular instruction requests that the command package name be placed in the names attribute of a JSON file; however, it should be understood that the type of file may be of other formats, such as but not limited to, an XML file.

Output instructions may also include instructions to provide certain output in scenarios where event log data was not provided as expected. For example, an output instruction such as the following may also be provided to the command package model 124:
It is possible that the request is not a set of event logs. If this is the case, return the following: JSON: {invalid_json}.

For example:
response_json={“package_label”: “ ”}
invalid_json={“response”: “This is not a valid request”}

Output instructions may also include instructions to provide outputs for certain scenarios, for example:
If no package exists for a given application_name, but there is a valid url, and the win_process_name or title involves a web browser, select the Browser.
Select only a single package.
Only output the response JSON.

In some implementations, output constraint instructions are also provided to each of the models. For example, such instructions may prohibit the models from producing output in certain situations, such as when certain outputs would not be suitable for use in an automation program or would not be suitable for use as an input instruction for a next model in the automation production process, when a user's request is not related to the purpose or design of the model since in such a situation the model would not be configured to address the user's request, or when the user's request is not clear such that the model would not be able to properly understand and process the user's request. Such output constraint instructions aim to minimize the degree to which large language models may produce outputs that are inaccurate, not properly pertaining to a user's request.

In some implementations, the order in which such instructions are provided to each of the models is arranged in a certain order to increase the relevancy and accuracy of the model outputs.

In block 508, instructions and data are provided to the action model 126 so that the model can identify actions suitable for placing in automation programs for automating the processes described in the event logs. In some implementations, command package model 124 is a large language model.

A set of data and instructions is provided to action model 126 each time a event group is provided so that the model can identify one or more actions for automating the events in the group. In this way, the models provide outputs for one group at a time and are able to provide outputs that will more accurately form part of automation programs to automate processes as defined in event logs. The types of data provided to action model 126 can include: 1) role definition instructions; 2) functional instructions; 3) domain knowledge; 4) event data for a grouping of events; 5) the command package names for the grouping of events that was previously identified by the command package model 124; and 6) output instructions. In some implementations, output constraints can also be provided to the models.

One example of a role definition instruction for the purposes of creating automation programs is:
You are a smart assistant for a software process automation platform and you are to assist a developer develop an automation program.

As for the command package model 124, the role definition instruction for the action model 126 may also name specific process automation platforms, e.g., automation platform provided by Automation Anywhere, Inc. The above role definition instruction may be worded differently in alternative embodiments so long as the model is able to process and identify the meaning of the instruction.

Functional instructions to be provided to action model 126 can be as follows:
You are given a series of events.
Create an action for each event.
Using available actions, create a possible sequence of actions to build an automation program and put the flow as part of a JSON file in the correct order.

Domain knowledge inputs to be provided to the action model 126 include information relating to event logs and the type of parameters defined for data within such event logs and a listing of available actions that correspond to the command packages that was previously identified by the command package model 124. An example of a domain knowledge input to provide information relating to event logs and associated parameters is as follows:
The event logs have the following parameters:
“action”: an action a user performed during an event that is part of a business or personal process that is to be automated, such as a MOUSE_CLICK or KEY_PRESS.
“control_type”: the control type interacted with. Examples are button, text_field, list_box, radio_button, checkbox, table, table_column, tab, icon.
“field” or “control type label”: the label of a control type. Example: if it was a button that said “OK”, “OK” would be the field.
“value” or “control type value”: The key pressed, or mouse button clicked.
“window title”: the title of the active window pulled from the operating system API information.
“URL”: If the user is using a web-based application, this is the website's URL.

Note that the order and wording of the above domain knowledge could vary and is presented above as one example of the domain knowledge instructions.

Domain knowledge input that provides information about the actions that correspond to the identified command packages can be provided to the action model 126 as follows:
Only the following action commands are available for you to build the workflow you need: {action_context}.
Each item follows the format: package_label|command_label|command description.

{action_context} represents a field into which that available actions can be programmatically be provided by the model integration module 130. The action model 126 is able to review the available actions and identify the one or more actions needed to allow an automation program to automate, or programmatically perform, the actions described in event data. The available actions can be provided in a spreadsheet formatted list as shown in FIG. 6. In some implementations, {action_context} can be provided to LLMs in a text string format, such as in CSV format, by converting the command package and action information in spreadsheet format into text string format.

The event log data may be provided to the action model 126 using an instruction that reads as follows:
Event logs: {event_logs}

{event_logs} represents a field into which event data for an event group will be inserted, e.g., by the model integration module 130. In some implementations, events for one group of events are provided in each set of instructions; however, in other implementations events for multiple groups of events may be provided. Each group of event logs can be provided in a spreadsheet format as seen in FIGS. 4A and 4B. In other implementations, the event log data in spreadsheet format can be converted to text string format, such as CSV format, before being provided to an LLM.

An input instruction to provide the command package names previously identified by the command package model 124 can be as follows:
The package identified to achieve this task is {selected_package}. The package has actions, each of which perform a specific operation.

{selected_package} represents a field into which the previously identified command package names will be programmatically filled, for example, by the model integration module 130.

In some implementations, output constraint instructions are also provided to the action model 126. For example, the following instruction could be provided:
Do not write a command package name and an action name that doesn't exist in the list of actions.
Use the following format as template for the JSON response: {response_json}.
Do not include any fields from the event logs.
Only output the response JSON.
Create a single action for each event.

After receiving and the above inputs for one group of events, the action model 126 is able to provide an action for each event in the group.

In block 510, the one or more actions provided by the action model 126 are arranged to be in a certain sequence, if necessary, so that the group of events as described in the event log can be properly automated.

In decision block 512, the model integration module 130 determines if another group of event data is awaiting to be provided to the command package model 124 and action model 126 so that command packages and actions can be identified for the purpose of creating an automation program that can automate the events within the group. If another group of events is awaiting to be provided, then the automation production process returns to block 504 such that model integration module 130 can facilitate the providing of inputs and data according to the processes described for blocks 504, 508 and 510.

When all of the groups of events have passed through the automation production process, then decision block 512 passes the production process onto block 514 where the ordered actions for the one or more groups of events are loaded into an automation program editor of the automation platform 110. With the actions loaded into an automation program editor, a user or develop has the option and ability to modify the actions, the order of the actions, and various parameters, such as attributes, or the actions. A developer may desire to make such modifications in case different automation results are desired.

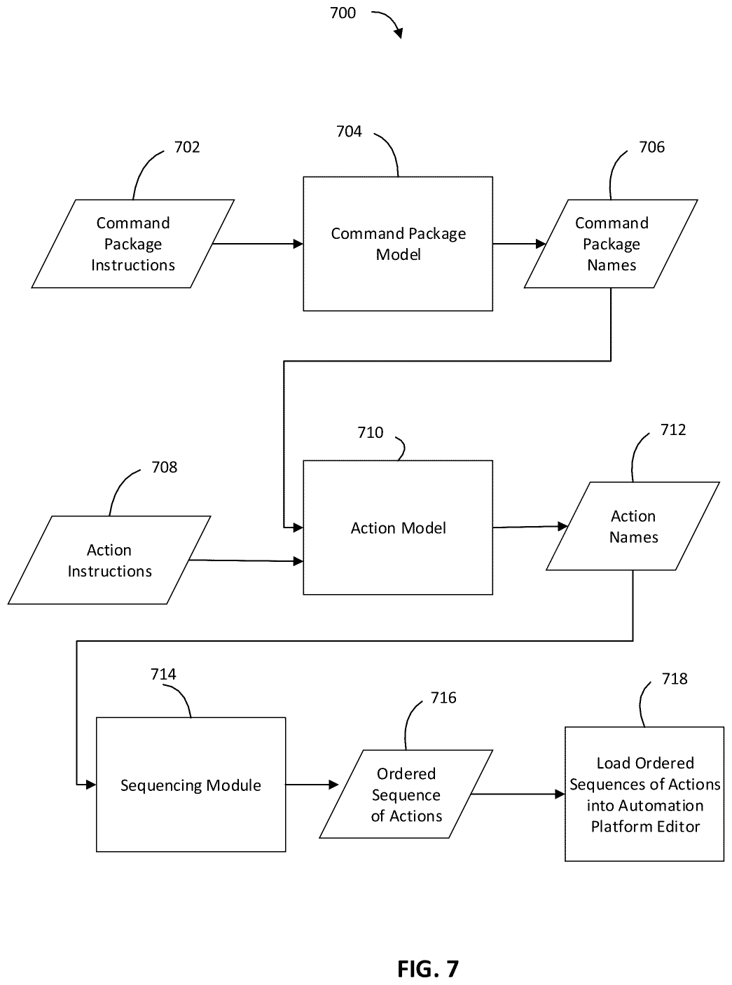

FIG. 7 illustrates an alternative process flow 700 for automation production according to techniques described herein. The process flow 700 begins when command package instructions 702 are provided to a command package model in block 704. The command package instructions 702 can include: 1) role definition instructions; 2) functional instruction; 3) domain knowledge; 4) event data for a grouping of events; 5) output instructions, and in some implementations, output constraint instructions. The command package model uses the command package instructions 702 to output one or more command package names 706 that can be used to create an automation program capable of automating the events defined in an event log.

The command package names 706 and action instructions 708 are then provided as inputs into an action model in block 710. The action instructions 708 can include: 1) role definition instructions; 2) functional instructions; 3) domain knowledge; 4) event data for a grouping of events; 5) the command package names for the grouping of events that was previously identified by the command package model 124; and 6) output instructions, and in some implementations, output constraint instructions. The action model uses the identified one or more command package names 706 and the action instructions 708 to output one or more action names 712 that can be used to create an automation program capable of automating the events defined in an event log.

In block 714, the identified one or more action names are provided to the sequencing model 128 so that the one or more identified actions can be placed in an order that can properly automate the events defined in an event log. The sequencing module 128 outputs the ordered sequence of actions 716, which can then be loaded into an automation program editor, in block 718, which is part of the automation platform 110.

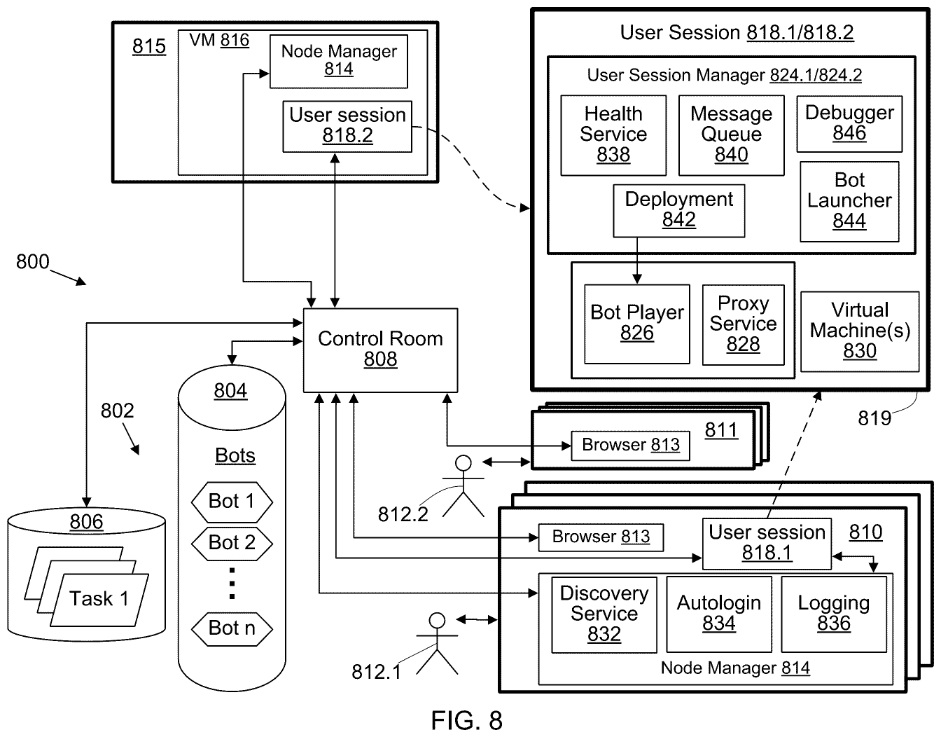

FIG. 8 is a block diagram of a robotic process automation (RPA) system 800 according to one embodiment. The RPA system 800 includes data storage 802. The data storage 802 can store a plurality of software robots 804, also referred to as bots (e.g., Bot 1, Bot 2, . . . , Bot n). The software robots 804 can be operable to interact at a user level with one or more user level application programs (not shown). As used herein, the term “bot” is generally synonymous with the term software robot. In certain contexts, as will be apparent to those skilled in the art in view of the present disclosure, the term “bot runner” refers to a device (virtual or physical), having the necessary software capability (such as bot player 826), on which a bot will execute or is executing. The data storage 802 can also store a plurality of work items 806. Each work item 806 can pertain to processing executed by one or more of the software robots 804.

The RPA system 800 can also include a control room 808. The control room 808 is operatively coupled to the data storage 802 and is configured to execute instructions that, when executed, cause the RPA system 800 to respond to a request from a client device 810 that is issued by a user 812.1. The control room 808 can act as a server to provide to the client device 810 the capability to perform an automation task to process a work item from the plurality of work items 806. The RPA system 800 is able to support multiple client devices 810 concurrently, each of which will have one or more corresponding user session(s) 818, which provides a context. The context can, for example, include security, permissions, audit trails, etc. to define the permissions and roles for bots operating under the user session 818. For example, a bot executing under a user session, cannot access any files or use any applications that the user, under whose credentials the bot is operating, does not have permission to do so. This prevents any inadvertent or malicious acts from a bot under which bot 804 executes.

The control room 808 can provide, to the client device 810, software code to implement a node manager 814. The node manager 814 executes on the client device 810 and provides a user 812 a visual interface via browser 813 to view progress of and to control execution of automation tasks. It should be noted that the node manager 814 can be provided to the client device 810 on demand, when required by the client device 810, to execute a desired automation task. In one embodiment, the node manager 814 may remain on the client device 810 after completion of the requested automation task to avoid the need to download it again. In another embodiment, the node manager 814 may be deleted from the client device 810 after completion of the requested automation task. The node manager 814 can also maintain a connection to the control room 808 to inform the control room 808 that device 810 is available for service by the control room 808, irrespective of whether a live user session 818 exists. When executing a bot 804, the node manager 814 can impersonate the user 812 by employing credentials associated with the user 812.

The control room 808 initiates, on the client device 810, a user session 818 (seen as a specific instantiation 818.1) to perform the automation task. The control room 808 retrieves the set of task processing instructions 804 that correspond to the work item 806. The task processing instructions 804 that correspond to the work item 806 can execute under control of the user session 818.1, on the client device 810. The node manager 814 can provide update data indicative of status of processing of the work item to the control room 808. The control room 808 can terminate the user session 818.1 upon completion of processing of the work item 806. The user session 818.1 is shown in further detail at 819, where an instance 824.1 of user session manager 824 is seen along with a bot player 826, proxy service 828, and one or more virtual machine(s) 830, such as a virtual machine that runs Java® or Python®. The user session manager 824 provides a generic user session context within which a bot 804 executes.

The bots 804 execute on a player, via a computing device, to perform the functions encoded by the bot. Some or all of the bots 804 may in certain embodiments be located remotely from the control room 808. Moreover, the devices 810 and 811, which may be conventional computing devices, such as for example, personal computers, server computers, laptops, tablets and other portable computing devices, may also be located remotely from the control room 808. The devices 810 and 811 may also take the form of virtual computing devices. The bots 804 and the work items 806 are shown in separate containers for purposes of illustration but they may be stored in separate or the same device(s), or across multiple devices. The control room 808 can perform user management functions, source control of the bots 804, along with providing a dashboard that provides analytics and results of the bots 804, performs license management of software required by the bots 804 and manages overall execution and management of scripts, clients, roles, credentials, security, etc. The major functions performed by the control room 808 can include: (i) a dashboard that provides a summary of registered/active users, tasks status, repository details, number of clients connected, number of scripts passed or failed recently, tasks that are scheduled to be executed and those that are in progress; (ii) user/role management—permits creation of different roles, such as bot creator, bot runner, admin, and custom roles, and activation, deactivation and modification of roles; (iii) repository management—to manage all scripts, tasks, workflows and reports etc.; (iv) operations management—permits checking status of tasks in progress and history of all tasks, and permits the administrator to stop/start execution of bots currently executing; (v) audit trail—logs creation of all actions performed in the control room; (vi) task scheduler—permits scheduling tasks which need to be executed on different clients at any particular time; (vii) credential management—permits password management; and (viii) security: management—permits rights management for all user roles. The control room 808 is shown generally for simplicity of explanation. Multiple instances of the control room 808 may be employed where large numbers of bots are deployed to provide for scalability of the RPA system 800.

In the event that a device, such as device 811 (e.g., operated by user 812.2) does not satisfy the minimum processing capability to run a node manager 814, the control room 808 can make use of another device, such as device 815, that has the requisite capability. In such case, a node manager 814 within a Virtual Machine (VM), seen as VM 816, can be resident on the device 815. The node manager 814 operating on the device 815 can communicate with browser 813 on device 811. This approach permits RPA system 800 to operate with devices that may have lower processing capability, such as older laptops, desktops, and portable/mobile devices such as tablets and mobile phones. In certain embodiments the browser 813 may take the form of a mobile application stored on the device 811. The control room 808 can establish a user session 818.2 for the user 812.2 while interacting with the control room 808 and the corresponding user session 818.2 operates as described above for user session 818.1 with user session manager 824 operating on device 810 as discussed above.

In certain embodiments, the user session manager 824 can provide five functions. First is a health service 838 that maintains and provides a detailed logging of bot execution including monitoring memory and CPU usage by the bot and other parameters such as number of file handles employed. The bots 804 can employ the health service 838 as a resource to pass logging information to the control room 808. Execution of the bot is separately monitored by the user session manager 824 to track memory, CPU, and other system information. The second function provided by the user session manager 824 is a message queue 840 for exchange of data between bots executed within the same user session 818. The third function is a deployment service (also referred to as a deployment module) 842 that connects to the control room 808 to request execution of a requested bot 804. The deployment service 842 can also ensure that the environment is ready for bot execution, such as by making available dependent libraries. The fourth function is a bot launcher 844 which can read metadata associated with a requested bot 804 and launch an appropriate container and begin execution of the requested bot. The fifth function is a debugger service 846 that can be used to debug bot code.

The bot player 826 can execute, or play back, a sequence of instructions encoded in a bot. The sequence of instructions can, for example, be captured by way of a recorder when a human performs those actions, or alternatively the instructions are explicitly coded into the bot. These instructions enable the bot player 826, to perform the same actions as a human would do in their absence. In one implementation, the instructions can compose of a command (action) followed by set of parameters, for example: Open Browser is a command, and a URL would be the parameter for it to launch a web resource. Proxy service 828 can enable integration of external software or applications with the bot to provide specialized services. For example, an externally hosted artificial intelligence system could enable the bot to understand the meaning of a “sentence.”

The user 812.1 can interact with node manager 814 via a conventional browser 813 which employs the node manager 814 to communicate with the control room 808. When the user 812.1 logs in from the client device 810 to the control room 808 for the first time, the user 812.1 can be instructed to download and install the node manager 814 on the device 810, if one is not already present. The node manager 814 can establish a web socket connection to the user session manager 824, deployed by the control room 808 that lets the user 812.1 subsequently create, edit, and deploy the bots 804.

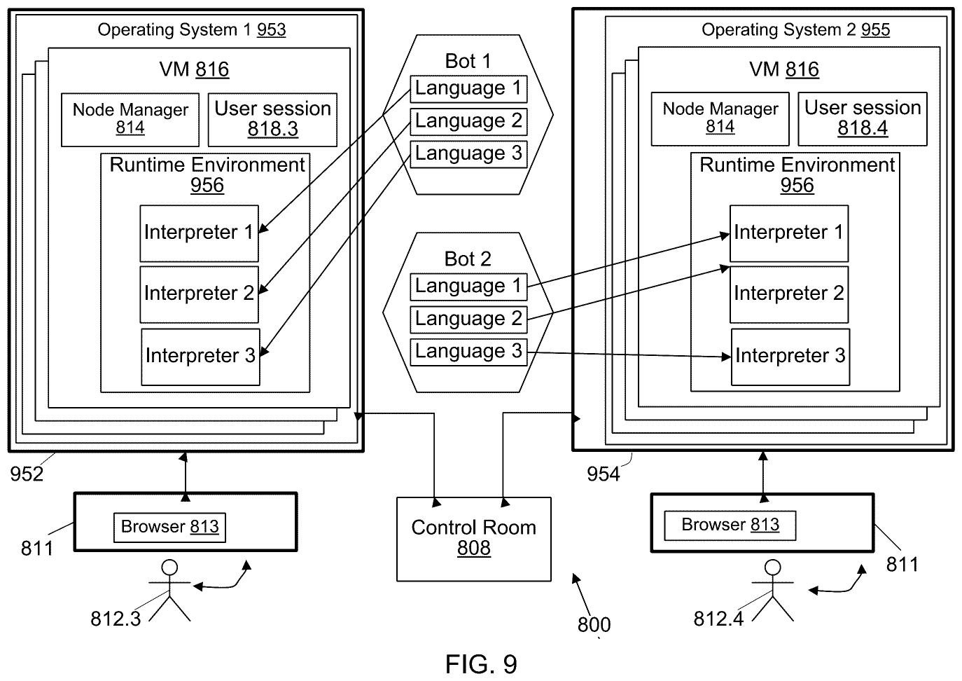

FIG. 9 is a block diagram of a generalized runtime environment for bots 804 in accordance with another embodiment of the RPA system 800 illustrated in FIG. 8. This flexible runtime environment advantageously permits extensibility of the platform to enable use of various languages in encoding bots. In the embodiment of FIG. 9, RPA system 800 generally operates in the manner described in connection with FIG. 8, except that in the embodiment of FIG. 9, some or all of the user sessions 818 execute within a virtual machine 816. This permits the bots 804 to operate on an RPA system 800 that runs on an operating system different from an operating system on which a bot 804 may have been developed. For example, if a bot 804 is developed on the Windows® operating system, the platform agnostic embodiment shown in FIG. 9 permits the bot 804 to be executed on a device 952 or 954 executing an operating system 953 or 955 different than Windows®, such as, for example, Linux. In one embodiment, the VM 816 takes the form of a Java Virtual Machine (JVM) as provided by Oracle Corporation. As will be understood by those skilled in the art in view of the present disclosure, a JVM enables a computer to run Java® programs as well as programs written in other languages that are also compiled to Java® bytecode.

In the embodiment shown in FIG. 9, multiple devices 952 can execute operating system 1, 953, which may, for example, be a Windows® operating system. Multiple devices 954 can execute operating system 2, 955, which may, for example, be a Linux® operating system. For simplicity of explanation, two different operating systems are shown, by way of example and additional operating systems such as the macOS®, or other operating systems may also be employed on devices 952, 954 or other devices. Each device 952, 954 has installed therein one or more VM's 816, each of which can execute its own operating system (not shown), which may be the same or different than the host operating system 953/955. Each VM 816 has installed, either in advance, or on demand from control room 808, a node manager 814. The embodiment illustrated in FIG. 9 differs from the embodiment shown in FIG. 8 in that the devices 952 and 954 have installed thereon one or more VMs 816 as described above, with each VM 816 having an operating system installed that may or may not be compatible with an operating system required by an automation task. Moreover, each VM has installed thereon a runtime environment 956, each of which has installed thereon one or more interpreters (shown as interpreter 1, interpreter 2, interpreter 3). Three interpreters are shown by way of example but any run time environment 956 may, at any given time, have installed thereupon less than or more than three different interpreters. Each interpreter 956 is specifically encoded to interpret instructions encoded in a particular programming language. For example, interpreter 1 may be encoded to interpret software programs encoded in the Java® programming language, seen in FIG. 9 as language 1 in Bot 1 and Bot 2. Interpreter 2 may be encoded to interpret software programs encoded in the Python® programming language, seen in FIG. 9 as language 2 in Bot 1 and Bot 2, and interpreter 3 may be encoded to interpret software programs encoded in the R programming language, seen in FIG. 9 as language 3 in Bot 1 and Bot 2.

Turning to the bots Bot 1 and Bot 2, each bot may contain instructions encoded in one or more programming languages. In the example shown in FIG. 9, each bot can contain instructions in three different programming languages, for example, Java®, Python® and R. This is for purposes of explanation and the embodiment of FIG. 9 may be able to create and execute bots encoded in more or less than three programming languages. The VMs 816 and the runtime environments 956 permit execution of bots encoded in multiple languages, thereby permitting greater flexibility in encoding bots. Moreover, the VMs 816 permit greater flexibility in bot execution. For example, a bot that is encoded with commands that are specific to an operating system, for example, open a file, or that requires an application that runs on a particular operating system, for example, Excel® on Windows®, can be deployed with much greater flexibility. In such a situation, the control room 808 will select a device with a VM 816 that has the Windows® operating system and the Excel® application installed thereon. Licensing fees can also be reduced by serially using a particular device with the required licensed operating system and application(s), instead of having multiple devices with such an operating system and applications, which may be unused for large periods of time.

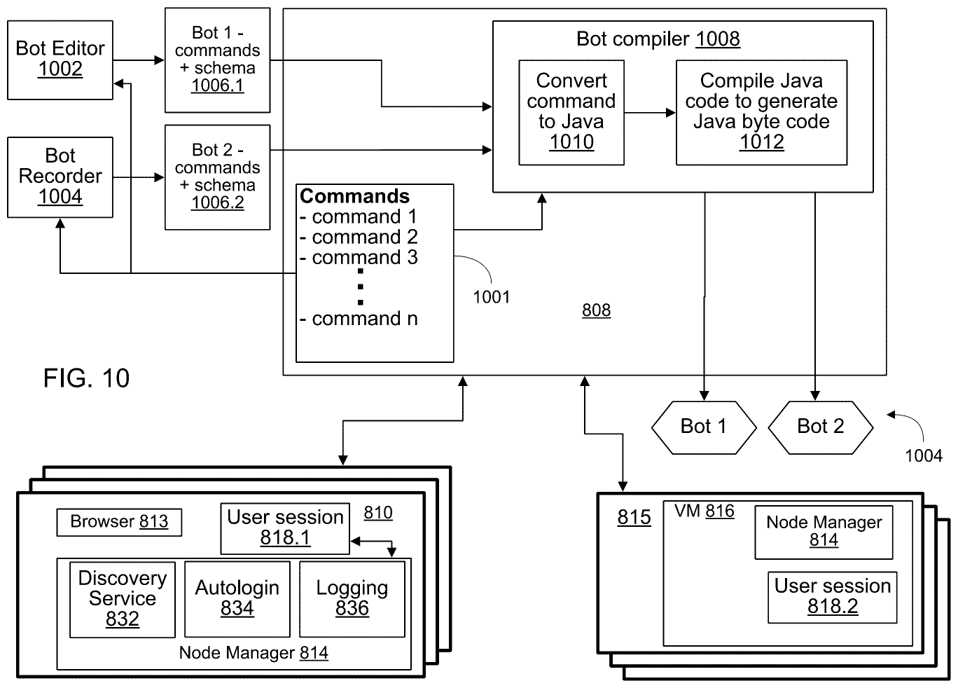

FIG. 10 illustrates a block diagram of yet another embodiment of the RPA system 800 of FIG. 8 configured to provide platform independent sets of task processing instructions for bots 804. Two bots 804, bot 1 and bot 2 are shown in FIG. 10. Each of bots 1 and 2 are formed from one or more commands 1001, each of which specifies a user level operation with a specified application program, or a user level operation provided by an operating system. Sets of commands 1006.1 and 1006.2 may be generated by bot editor 1002 and bot recorder 1004, respectively, to define sequences of application-level operations that are normally performed by a human user. The bot editor 1002 may be configured to combine sequences of commands 1001 via an editor. The bot recorder 1004 may be configured to record application-level operations performed by a user and to convert the operations performed by the user to commands 1001. The sets of commands 1006.1 and 1006.2 generated by the editor 1002 and the recorder 1004 can include command(s) and schema for the command(s), where the schema defines the format of the command(s). The format of a command can, such as, includes the input(s) expected by the command and their format. For example, a command to open a URL might include the URL, a user login, and a password to login to an application resident at the designated URL.

The control room 808 operates to compile, via compiler 1008, the sets of commands generated by the editor 1002 or the recorder 1004 into platform independent executables, each of which is also referred to herein as a bot JAR (Java ARchive) that perform application-level operations captured by the bot editor 1002 and the bot recorder 1004. In the embodiment illustrated in FIG. 10, the set of commands 1006, representing a bot file, can be captured in a JSON (JavaScript Object Notation) format which is a lightweight data-interchange text-based format. JSON is based on a subset of the JavaScript Programming Language Standard ECMA-262 3rd Edition—December 1999. JSON is built on two structures: (i) a collection of name/value pairs; in various languages, this is realized as an object, record, struct, dictionary, hash table, keyed list, or associative array, (ii) an ordered list of values which, in most languages, is realized as an array, vector, list, or sequence. Bots 1 and 2 may be executed on devices 810 and/or 815 to perform the encoded application-level operations that are normally performed by a human user.

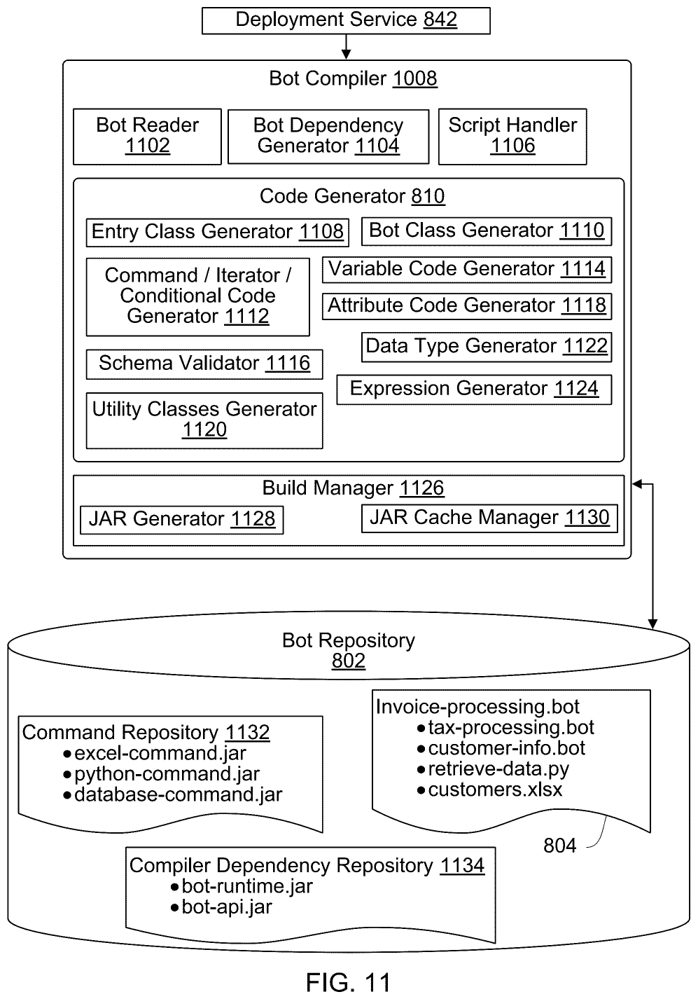

FIG. 11 is a block diagram illustrating details of one embodiment of the bot compiler 1008 illustrated in FIG. 10. The bot compiler 1008 accesses one or more of the bots 804 from the data storage 802, which can serve as bot repository, along with commands 1001 that are contained in a command repository 1132. The bot compiler 808 can also access compiler dependency repository 1134. The bot compiler 808 can operate to convert each command 1001 via code generator module 1010 to an operating system independent format, such as a Java command. The bot compiler 808 then compiles each operating system independent format command into byte code, such as Java byte code, to create a bot JAR. The convert command to Java module 1010 is shown in further detail in in FIG. 11 by JAR generator 1128 of a build manager 1126. The compiling to generate Java byte code module 1012 can be provided by the JAR generator 1128. In one embodiment, a conventional Java compiler, such as javac from Oracle Corporation, may be employed to generate the bot JAR (artifacts). As will be appreciated by those skilled in the art, an artifact in a Java environment includes compiled code along with other dependencies and resources required by the compiled code. Such dependencies can include libraries specified in the code and other artifacts. Resources can include web pages, images, descriptor files, other files, directories and archives.

As noted in connection with FIG. 10, deployment service 842 can be responsible to trigger the process of bot compilation and then once a bot has compiled successfully, to execute the resulting bot JAR on selected devices 810 and/or 815. The bot compiler 1008 can comprises a number of functional modules that, when combined, generate a bot 804 in a JAR format. A bot reader 1102 loads a bot file into memory with class representation. The bot reader 1102 takes as input a bot file and generates an in-memory bot structure. A bot dependency generator 1104 identifies and creates a dependency graph for a given bot. It includes any child bot, resource file like script, and document or image used while creating a bot. The bot dependency generator 1104 takes, as input, the output of the bot reader 1102 and provides, as output, a list of direct and transitive bot dependencies. A script handler 1106 handles script execution by injecting a contract into a user script file. The script handler 1106 registers an external script in manifest and bundles the script as a resource in an output JAR. The script handler 1106 takes, as input, the output of the bot reader 1102 and provides, as output, a list of function pointers to execute different types of identified scripts like Python, Java, VB scripts.

An entry class generator 1108 can create a Java class with an entry method, to permit bot execution to be started from that point. For example, the entry class generator 1108 takes, as an input, a parent bot name, such “Invoice-processing.bot” and generates a Java class having a contract method with a predefined signature. A bot class generator 1110 can generate a bot class and orders command code in sequence of execution. The bot class generator 1110 can take, as input, an in-memory bot structure and generates, as output, a Java class in a predefined structure. A Command/Iterator/Conditional Code Generator 1112 wires up a command class with singleton object creation, manages nested command linking, iterator (loop) generation, and conditional (If/Else If/Else) construct generation. The Command/Iterator/Conditional Code Generator 1112 can take, as input, an in-memory bot structure in JSON format and generates Java code within the bot class. A variable code generator 1114 generates code for user defined variables in the bot, maps bot level data types to Java language compatible types, and assigns initial values provided by user. The variable code generator 1114 takes, as input, an in-memory bot structure and generates Java code within the bot class. A schema validator 1116 can validate user inputs based on command schema and includes syntax and semantic checks on user provided values. The schema validator 1116 can take, as input, an in-memory bot structure and generates validation errors that it detects. The attribute code generator 1118 can generate attribute code, handles the nested nature of attributes, and transforms bot value types to Java language compatible types. The attribute code generator 1118 takes, as input, an in-memory bot structure and generates Java code within the bot class. A utility classes generator 1120 can generate utility classes which are used by an entry class or bot class methods. The utility classes generator 1120 can generate, as output, Java classes. A data type generator 1122 can generate value types useful at runtime. The data type generator 1122 can generate, as output, Java classes. An expression generator 1124 can evaluate user inputs and generates compatible Java code, identifies complex variable mixed user inputs, inject variable values, and transform mathematical expressions. The expression generator 1124 can take, as input, user defined values and generates, as output, Java compatible expressions.

The JAR generator 1128 can compile Java source files, produces byte code and packs everything in a single JAR, including other child bots and file dependencies. The JAR generator 1128 can take, as input, generated Java files, resource files used during the bot creation, bot compiler dependencies, and command packages, and then can generate a JAR artifact as an output. The JAR cache manager 1130 can put a bot JAR in cache repository so that recompilation can be avoided if the bot has not been modified since the last cache entry. The JAR cache manager 1130 can take, as input, a bot JAR.

In one or more embodiment described herein command action logic can be implemented by commands 1001 available at the control room 808. This permits the execution environment on a device 810 and/or 815, such as exists in a user session 818, to be agnostic to changes in the command action logic implemented by a bot 804. In other words, the manner in which a command implemented by a bot 804 operates need not be visible to the execution environment in which a bot 804 operates. The execution environment is able to be independent of the command action logic of any commands implemented by bots 804. The result is that changes in any commands 1001 supported by the RPA system 800, or addition of new commands 1001 to the RPA system 800, do not require an update of the execution environment on devices 810, 815. This avoids what can be a time and resource intensive process in which addition of a new command 1001 or change to any command 1001 requires an update to the execution environment to each device 810, 815 employed in an RPA system. Take, for example, a bot that employs a command 1001 that logs into an on-online service. The command 1001 upon execution takes a Uniform Resource Locator (URL), opens (or selects) a browser, retrieves credentials corresponding to a user on behalf of whom the bot is logging in as, and enters the user credentials (e.g., username and password) as specified. If the command 1001 is changed, for example, to perform two-factor authentication, then it will require an additional resource (the second factor for authentication) and will perform additional actions beyond those performed by the original command (for example, logging into an email account to retrieve the second factor and entering the second factor). The command action logic will have changed as the bot is required to perform the additional changes. Any bot(s) that employ the changed command will need to be recompiled to generate a new bot JAR for each changed bot and the new bot JAR will need to be provided to a bot runner upon request by the bot runner. The execution environment on the device that is requesting the updated bot will not need to be updated as the command action logic of the changed command is reflected in the new bot JAR containing the byte code to be executed by the execution environment.

The embodiments herein can be implemented in the general context of computer-executable instructions, such as those included in program modules, being executed in a computing system on a target, real or virtual, processor. Generally, program modules include routines, programs, libraries, objects, classes, components, data structures, etc. that perform particular tasks or implement particular abstract data types. The program modules may be obtained from another computer system, such as via the Internet, by downloading the program modules from the other computer system for execution on one or more different computer systems. The functionality of the program modules may be combined or split between program modules as desired in various embodiments. Computer-executable instructions for program modules may be executed within a local or distributed computing system. The computer-executable instructions, which may include data, instructions, and configuration parameters, may be provided via an article of manufacture including a computer readable medium, which provides content that represents instructions that can be executed. A computer readable medium may also include a storage or database from which content can be downloaded. A computer readable medium may further include a device or product having content stored thereon at a time of sale or delivery. Thus, delivering a device with stored content, or offering content for download over a communication medium, may be understood as providing an article of manufacture with such content described herein.

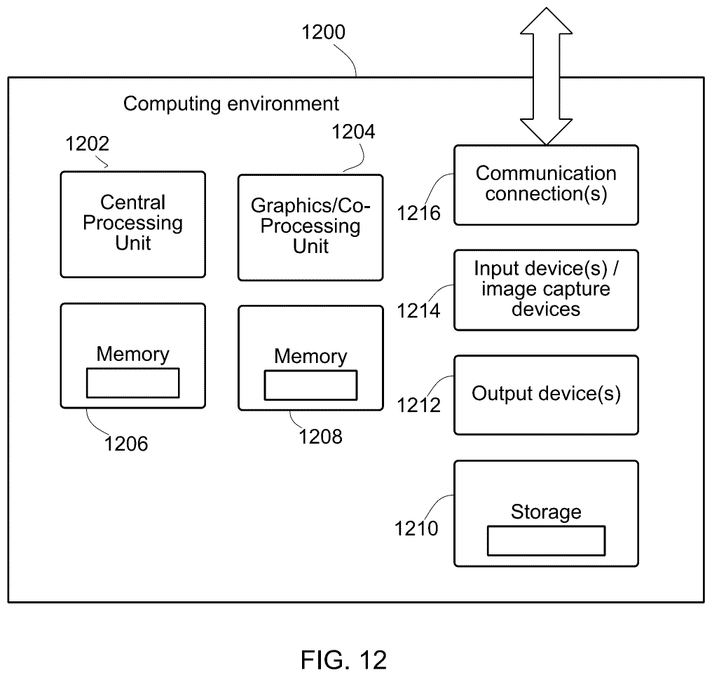

FIG. 12 illustrates a block diagram of an exemplary computing environment 1200 for an implementation of an RPA system, such as the RPA systems disclosed herein. The embodiments described herein may be implemented using the exemplary computing environment 1200. The exemplary computing environment 1200 includes one or more processing units 1202, 1204 and memory 1206, 1208. The processing units 1202, 1206 execute computer-executable instructions. Each of the processing units 1202, 1206 can be a general-purpose central processing unit (CPU), processor in an application-specific integrated circuit (ASIC) or any other type of processor. For example, as shown in FIG. 12, the processing unit 1202 can be a CPU, and the processing unit can be a graphics/co-processing unit (GPU). The tangible memory 1206, 1208 may be volatile memory (e.g., registers, cache, RAM), non-volatile memory (e.g., ROM, EEPROM, flash memory, etc.), or some combination of the two, accessible by the processing unit(s). The hardware components may be standard hardware components, or alternatively, some embodiments may employ specialized hardware components to further increase the operating efficiency and speed with which the RPA system operates. The various components of exemplary computing environment 1200 may be rearranged in various embodiments, and some embodiments may not require nor include all of the above components, while other embodiments may include additional components, such as specialized processors and additional memory.

The exemplary computing environment 1200 may have additional features such as, for example, tangible storage 1210, one or more input devices 1214, one or more output devices 1212, and one or more communication connections 1216. An interconnection mechanism (not shown) such as a bus, controller, or network can interconnect the various components of the exemplary computing environment 1200. Typically, operating system software (not shown) provides an operating system for other software executing in the exemplary computing environment 1200, and coordinates activities of the various components of the exemplary computing environment 1200.

The tangible storage 1210 may be removable or non-removable, and includes magnetic disks, magnetic tapes or cassettes, CD-ROMs, DVDs, or any other medium which can be used to store information in a non-transitory way, and which can be accessed within the computing system 1200. The tangible storage 1210 can store instructions for the software implementing one or more features of a PRA system as described herein.

The input device(s) or image capture device(s) 1214 may include, for example, one or more of a touch input device (such as a keyboard, mouse, pen, or trackball), a voice input device, a scanning device, an imaging sensor, touch surface, or any other device capable of providing input to the exemplary computing environment 1200. For multimedia embodiment, the input device(s) 1214 can, for example, include a camera, a video card, a TV tuner card, or similar device that accepts video input in analog or digital form, a microphone, an audio card, or a CD-ROM or CD-RW that reads audio/video samples into the exemplary computing environment 1200. The output device(s) 1212 can, for example, include a display, a printer, a speaker, a CD-writer, or any another device that provides output from the exemplary computing environment 1200.

The one or more communication connections 1216 can enable communication over a communication medium to another computing entity. The communication medium conveys information such as computer-executable instructions, audio or video input or output, or other data. The communication medium can include a wireless medium, a wired medium, or a combination thereof.

The various aspects, features, embodiments or implementations of the invention described above can be used alone or in various combinations.

Embodiments of the invention can, for example, be implemented by software, hardware, or a combination of hardware and software. Embodiments of the invention can also be embodied as computer readable code on a computer readable medium. In one embodiment, the computer readable medium is non-transitory. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

The embodiments herein can be implemented in the general context of computer-executable instructions, such as those included in program modules, being executed in a computing system on a target, real or virtual, processor. Generally, program modules include routines, programs, libraries, objects, classes, components, data structures, etc. that perform particular tasks or implement particular abstract data types. The program modules may be obtained from another computer system, such as via the Internet, by downloading the program modules from the other computer system for execution on one or more different computer systems. The functionality of the program modules may be combined or split between program modules as desired in various embodiments. Computer-executable instructions for program modules may be executed within a local or distributed computing system. The computer-executable instructions, which may include data, instructions, and configuration parameters, may be provided via an article of manufacture including a computer readable medium, which provides content that represents instructions that can be executed. A computer readable medium may also include a storage or database from which content can be downloaded. A computer readable medium may further include a device or product having content stored thereon at a time of sale or delivery. Thus, delivering a device with stored content, or offering content for download over a communication medium, may be understood as providing an article of manufacture with such content described herein.

Numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

In the foregoing description, reference to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer-implemented method for producing an automation program, the method comprising:
receiving, by a data processing module, an event log comprising event data related to one or more user actions performed using one or more software applications for the purpose of completing a task;
separating the event log into a plurality of event groups wherein each of the event group includes at least one or more events, and wherein each of the event groups has associated therewith the event data for the one or more events of the corresponding event group, wherein each event includes data regarding a user action;
providing command package inputs, by a model integration module, to a command package model, the command package inputs including a role definition instruction, command package domain knowledge, the event data for the one or more events of the corresponding event group, command package model functional instructions, and command package model output instructions;
identifying a command package name, by the command package model, based on the command package inputs, wherein the command package name is associated with a command package that contains one or more actions that can be executed within one or more of the software applications;
providing action model inputs, by the model integration module, to an action model, wherein the action model inputs include at least a role definition instruction, action domain knowledge, the event data for the one or more events of the corresponding event group, action model functional instructions, the command package name identified by the command package model, and action model output instructions;
identifying one or more action names, by the action model, based on the action model inputs, wherein the identified one or more action names are associated with respective one or more actions that are suitable for automating the user actions in the event log; and
combining, by a sequencing module, the respective one or more actions suggested by the action model in a sequence wherein execution of the respective one or more actions automates the events within the corresponding event group.

2. A computer-implemented method as recited in claim 1, wherein the one or more events of each event group pertain to user actions performed using the same software application.

3. A computer-implemented method as recited in claim 1, wherein providing the command package domain knowledge to the command package model comprises:
providing an indication of event log parameters wherein each event log parameter corresponds to a respective type of information associated with the event log,
wherein the event log parameters include an application name, a window title, a URL, and an application API name.

4. A computer-implemented method as recited in claim 3, wherein the method comprises:
providing event data for the one or more events of an event group wherein the event data includes data corresponding to the event log parameters of application name, window title, URL, and application API name.

5. A computer-implemented method as recited in claim 4, wherein providing the event data for the one or more events of an event group comprises:
providing the event data in comma separated value format.

6. A computer-implemented method for producing an automation program, the method of claim 1 wherein the command package domain knowledge includes at least a plurality of command package names and a description of the actions that are available within each respective command package.

7. A computer-implemented method as recited in claim 1, wherein the action domain knowledge includes at least an indication of event log parameters, wherein the event log parameters include one or more of: an action name, a control type, a control type label, a control type value, a window title, and a URL.

8. A computer-implemented method as recited in claim 1, wherein the event data for the one or more events of the corresponding event group includes one or more of: data corresponding to the action name, control type, control type label, control type value, window title, and URL.

9. A computer-implemented method for producing an automation program, the method of claim 1, wherein the providing to the action model the action domain knowledge comprises:
providing one or more action names associated with the command package identified by the command package model.

10. A computer-implemented method for producing an automation program, the method comprising:
receiving, by a data processing module, an event log comprising event data related to one or more user actions performed using one or more software applications for the purpose of completing a task;
separating the event log into a plurality of event groups wherein each of the event group includes at least one or more events, and wherein each of the event groups has associated therewith the event data for the one or more events of the corresponding event group, wherein each event includes data regarding a user action;
providing command package inputs, by a model integration module, to a command package model, the command package inputs including at least the event data for a selected one of the event groups;
identifying a command package name, by the command package model, based on the command package inputs, wherein the command package name is associated with a command package that contains one or more actions that can be executed within one or more of the software applications;
providing action model inputs, by the model integration module, to an action model, wherein the action model inputs including at least event data the selected one of the event groups and the command package name identified by the command package model;
identifying one or more action names, by the action model, based on the action model inputs, wherein the one or more action names are associated with respective one or more actions that are suitable for automating the user actions in the event log; and
combining, by a sequencing module, the respective one or more actions identified by the action model in a sequence wherein execution of the one or more actions automates the events within an event group.

11. A computer-implemented method as recited in claim 10, wherein the one or more events of each event group pertain to user actions performed using the same software application.

12. A computer-implemented method as recited in claim 10, wherein the command package model is a command package machine learning model that proposes at least one command package name, the command package machine learning model being a large language model.

13. A computer-implemented method as recited in claim 12, wherein the action model is an action machine learning model, the action machine learning model being a large language model.

14. A computer-implemented method as recited in claim 13, wherein the action machine learning model selects automation actions associated with the proposed command packages, to be incorporated within automation programs.

15. A computer readable medium including at least computer program code tangibly stored therein for producing an automation program, the computer readable medium comprising:
computer program code for receiving an event log comprising event data related to one or more user actions performed using one or more software applications for the purpose of completing a task;
computer program code for separating the event log into a plurality of event groups, each of the event group includes at least one or more events the event data for the one or more events;
computer program code for providing command package inputs, by a model integration module, to a command package model, the command package inputs including a role definition instruction, command package domain knowledge, the event data for the one or more events of the corresponding event group, command package model functional instructions, and command package model output instructions;
computer program code for identifying a command package name for the corresponding event group, the command package name being associated with a command package that includes or supports one or more actions that can be executed within one or more of the software applications;
computer program code for identifying one or more actions based on action model inputs, wherein the identified one or more actions are suitable for automating the user actions in the event log; and
computer program code for combining the identified one or more actions in a sequence, wherein execution of the sequence operates to induce the identified one or more actions that serve to automate the events within the corresponding event group.

16. A computer readable medium as recited in claim 15, wherein the command package model is a command package machine learning model that proposes at least one command package name.

17. A computer readable medium as recited in claim 16, wherein the command package machine learning model is a large language model.

18. A computer readable medium as recited in claim 17, wherein the action model is an action machine learning model.

19. A computer readable medium as recited in claim 18, wherein the action machine learning model is a large language model.

20. A computer readable medium as recited in claim 19, wherein the action machine learning model selects automation actions associated with the proposed command packages, to be incorporated within automation programs.

21. A computer readable medium as recited in claim 17, wherein the action model inputs include at least the event data for the one or more events of the corresponding event group, and the command package name identified by the command package model.

22. A computer readable medium as recited in claim 21, wherein the action model inputs include at least a role definition instruction.

23. A computer readable medium as recited in claim 22, wherein the action model inputs include at least action domain knowledge.

24. A computer readable medium as recited in claim 23, wherein the action model inputs include at least action model functional instructions, and action model output instructions.
